(19) United States
(12) Patent Application Publication
(10) Pub. No.: US 2026/0168472 A1
(43) Pub. Date: Jun. 18, 2026

(54) DEAERATOR

(71) Applicant: Fischer Panda Generators, LLC, Pompano Beach, FL (US)

(72) Inventor: Kyle Riebel, Pompano Beach, FL (US)

(73) Assignee: Fischer Panda Generators, LLC, Pompano Beach, FL (US)

(21) Appl. No.: 19/422,498

(22) Filed: Dec. 17, 2025

Related U.S. Application Data
(60) Provisional application No. 63/735,183, filed on Dec. 17, 2024.

(51) Int. Cl. F02M 37/54; F02M 37/00; F02M 37/32

(52) U.S. Cl. CPC F02M 37/54; F02M 37/0076; F02M 37/32

(57) ABSTRACT

A fuel deaeration system comprising a chassis fuel tank configured to store fuel, a fuel deaerator fluidly configured to receive the fuel and remove entrained air from the fuel, a fuel pump configured to draw fuel through the fuel deaerator and deliver the fuel at a predetermined flow rate, a fuel strainer, a fuel filter/water separator configured to receive fuel from the fuel pump and mitigate residual entrained air from the fuel, a generator fuel supply line fluidly coupled between the fuel filter/water separator and the generator, configured to receive filtered fuel from the fuel filter/water separator and deliver the filtered fuel to the generator, a generator return fuel line configured to return unused fuel and entrained air from the generator to the fuel deaerator. The fuel deaerator is configured to remove air introduced into the fuel from the generator through the generator return fuel line.

### CLAIM FOR PRIORITY

This application claims priority from prior provisional patent application 63/735,183 filed on Dec. 17, 2024. The entire collective teachings thereof being herein incorporated by reference.

### TECHNOLOGICAL FIELD

Example embodiments of the present disclosure generally relate to fuel supply systems for vehicle-mounted generators, and more particularly relate to a fuel deaeration system and method thereof.

### BACKGROUND

Conventional fuel management systems used on vehicles equipped with chassis-mounted diesel generators are commonly configured to draw fuel from a primary vehicle fuel tank and return unused fuel back to the same tank. However, certain vehicle chassis platforms impose operational restrictions that prohibit modification of the fuel system or prevent return fuel from being routed back into the chassis tank. These restrictions render conventional return-based fuel delivery systems incompatible with auxiliary generator installations, particularly where continuous fuel circulation is required for reliable operation. As a result, traditional generator fuel supply architectures cannot be implemented on such platforms without violating underlying operational or warranty constraints.

Earlier attempts to address these limitations included localized fuel circulation approaches and intermediate fuel storage configurations intended to avoid returning fuel to the chassis tank. While such solutions reduced reliance on direct return plumbing, they were not specifically designed for mobile generator applications operating under transient conditions. In practice, these systems were unable to consistently manage fuel stability during repeated start-stop cycles, shut-down intervals, and mobile operation, thereby failing to meet the reliability expectations of vehicle-mounted generator systems.

Diesel generator fuel systems further present technical challenges arising from inherent fuel aeration. Fuel returning from the generator's injection system commonly contains entrained air introduced during normal operation. When not properly managed, this entrained air accumulates within filters, fuel lines, or intermediate supply components. Although steady-state generator operation may remain acceptable, shutdown conditions allow small air bubbles to coalesce into larger air pockets, leading to hard starting, delayed ignition, or failed restart attempts following periods of inactivity. Dynamic condition such as bumps and cornering can further cause larger air pockets to be burped through the system and cause unintended stalling or shutdowns. These conditions are particularly problematic in recreational vehicle and motor-home applications, where generators are frequently cycled and reliable restarting is critical to user satisfaction and system usability.

Numerous methods and devices have been developed in an attempt to supply diesel fuel to auxiliary generators while maintaining compliance with vehicle fuel system restrictions. Such approaches include aftermarket fuel loop assemblies, modified filtering arrangements, and combinations of standalone components adapted from non-mobile applications. However, these solutions have proven inadequate for high-cycle, mobile environments and often lack effective air removal capabilities, resulting in persistent air accumulation within the fuel system. Additionally, these approaches typically require complex installation procedures, introduce multiple potential failure points, and necessitate increased maintenance intervention, thereby reducing overall system reliability and end-user confidence.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, a fuel deaeration system for a generator mounted on a vehicle chassis is disclosed. The fuel deaeration system comprises a chassis fuel tank configured to store fuel. The fuel deaeration system further comprises a fuel deaerator fluidly coupled to the chassis fuel tank and configured to receive the fuel therefrom and remove entrained air from the fuel. The fuel deaeration system further comprises a fuel pump fluidly coupled downstream of the fuel deaerator and configured to draw fuel through the fuel deaerator and deliver the fuel at a predetermined flow rate. The fuel deaeration system further comprises a fuel strainer fluidly coupled between the fuel deaerator and the fuel pump. Further, the fuel strainer is configured to protect the fuel pump from debris. The fuel deaeration system further comprises a fuel filter/water separator fluidly coupled downstream of the fuel pump and configured to receive fuel from the fuel pump and remove residual entrained air from the fuel. The fuel deaeration system further comprises a generator fuel supply line fluidly coupled between the fuel filter/water separator and the generator, and configured to receive filtered fuel from the fuel filter/water separator and deliver the filtered fuel to the generator. The fuel deaeration system further comprises a generator return fuel line fluidly coupled between the generator and the fuel deaerator and configured to return unused fuel and entrained air from the generator to the fuel deaerator. Further, the fuel deaerator is configured to remove air introduced into the fuel from the generator through the generator return fuel line.

In some embodiments, the fuel deaerator comprises a vent outlet configured to expel air from the fuel and to optionally route the expelled air externally of the vehicle chassis.

In some embodiments, the vent outlet includes a float valve configured to prevent liquid fuel discharge during fault conditions.

In some embodiments, the fuel deaerator is mounted at an elevation above the chassis fuel tank so as to inhibit siphoning of the fuel from the chassis fuel tank in cases of fuel deaerator failures and to maintain compliance with manufacturer requirements.

In some embodiments, the fuel pump comprises a positive-displacement pump configured to maintain a substantially continuous fuel velocity through the fuel filter/water separator to break up or dissolve microbubbles remaining after the fuel deaerator removes the entrained air from the fuel.

In some embodiments, the fuel filter/water separator is configured to dissipate microbubbles by at least one of: absorbing the microbubbles into the fuel under pressure, and mechanically subdividing the microbubbles into particles too small to interfere with operation of the generator.

In some embodiments, the generator fuel supply line and the generator return fuel line comprises one or more tubes having a predetermined internal diameter selected to reduce formation and accumulation of entrained air and minimize a number of hose connections among the chassis fuel tank, the fuel deaerator, the fuel pump, the fuel filter/water separator, and the generator.

In some embodiments, the predetermined internal diameter comprises approximately 5/16 inch, thereby reducing suction losses, minimizing air accumulation, and ensuring compatibility with multiple generator configurations.

In some embodiments, the generator return fuel line is fluidly isolated from the chassis fuel tank to preserve compliance with vehicle manufacturer restrictions prohibiting return of the fuel to the chassis fuel tank.

In some embodiments, the fuel deaeration system is configured to maintain a generator inlet fuel temperature below a predetermined threshold compliant with generator-manufacturer specifications during ambient temperatures of up to 48.9° C.

In another example embodiment, a method is disclosed. The method comprises steps of fluidly coupling a fuel deaerator to a chassis fuel tank stored with fuel, the fuel deaerator configured to receive the fuel therefrom and remove entrained air from the fuel. The method further comprises steps of fluidly coupling a fuel pump downstream of the fuel deaerator, the fuel pump configured to draw fuel through the fuel deaerator and deliver the fuel at a predetermined flow rate. The method further comprises steps of fluidly coupling a fuel strainer between the fuel deaerator and the fuel pump, the fuel strainer configured to filter out large debris and protect the fuel pump. The method further comprises steps of fluidly coupling a fuel filter/water separator downstream of the fuel pump, the fuel filter/water separator configured to receive fuel from the fuel pump and remove residual entrained air from the fuel. The method further comprises steps of fluidly coupling a generator fuel supply line between the fuel filter/water separator and a generator, the generator fuel supply line configured to receive filtered fuel from the fuel filter/water separator and deliver the filtered fuel to the generator. The method further comprises steps of fluidly coupling a generator return fuel line between the generator and the fuel deaerator, the generator return fuel line configured to return unused fuel and entrained air from the generator to the fuel deaerator. Further, the fuel deaerator is configured to remove air introduced into the fuel from the generator through the generator return fuel line.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1A illustrates a block diagram of a fuel deaeration system in accordance with an example embodiment of the present disclosure;

FIG. 1B illustrates an architectural view of the fuel deaeration system, in accordance with an example embodiment of the present disclosure;

FIG. 2 illustrate a perspective view of the fuel deaeration system installed on a vehicle chassis in accordance with an example embodiment of the present disclosure;

FIG. 3 illustrates an architectural view of the fuel deaeration system for a diesel engine in accordance with a second example embodiment of the present disclosure; and

FIG. 4 illustrates a flowchart showing a method in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a fuel deaeration system for a generator mounted on a vehicle chassis. The fuel deaeration system may comprise a chassis fuel tank configured to store fuel. The fuel deaeration system may further comprise a fuel deaerator fluidly coupled to the chassis fuel tank and may be configured to receive the fuel therefrom and remove entrained air from the fuel. The fuel deaeration system may further comprise a fuel pump fluidly coupled downstream of the fuel deaerator and may be configured to draw fuel through the fuel deaerator and deliver the fuel at a predetermined flow rate. The fuel deaeration system may further comprise a fuel strainer fluidly coupled between the fuel deaerator and the fuel pump, the fuel strainer may be configured to protect the fuel pump from debris. The fuel deaeration system may further comprise a fuel filter/water separator fluidly coupled downstream of the fuel pump and may be configured to receive fuel from the fuel pump and remove residual entrained air from the fuel. The fuel deaeration system may further comprise a generator fuel supply line fluidly coupled between the fuel filter/water separator and the generator, and may be configured to receive filtered fuel from the fuel filter/water separator and deliver the filtered fuel to the generator. The fuel deaeration system may further comprise a generator return fuel line fluidly coupled between the generator and the fuel deaerator and may be configured to return unused fuel and entrained air from the generator to the fuel deaerator. Further, the fuel deaerator may be configured to remove air introduced into the fuel from the generator through the generator return fuel line.

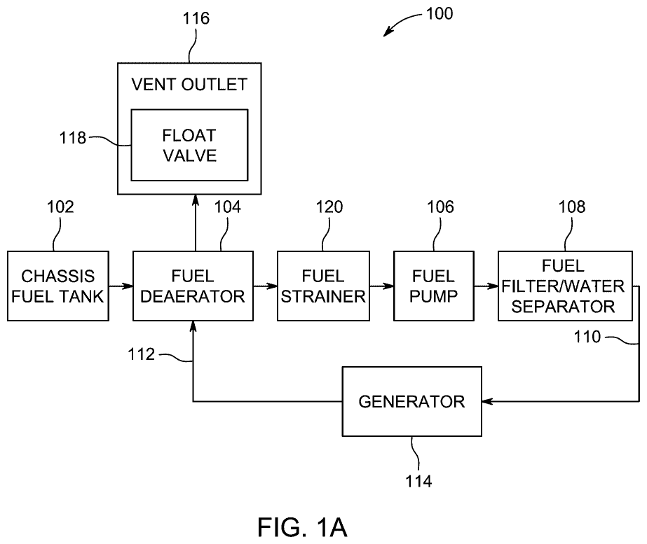

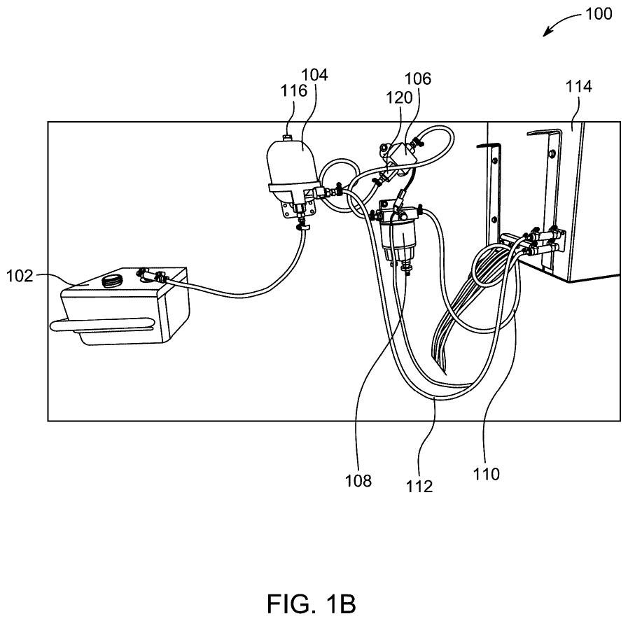

FIG. 1A illustrates a block diagram of a fuel deaeration system 100, in accordance with an example embodiment of the present disclosure. FIG. 1B illustrates an architectural view of the fuel deaeration system 100, in accordance with an example embodiment of the present disclosure.

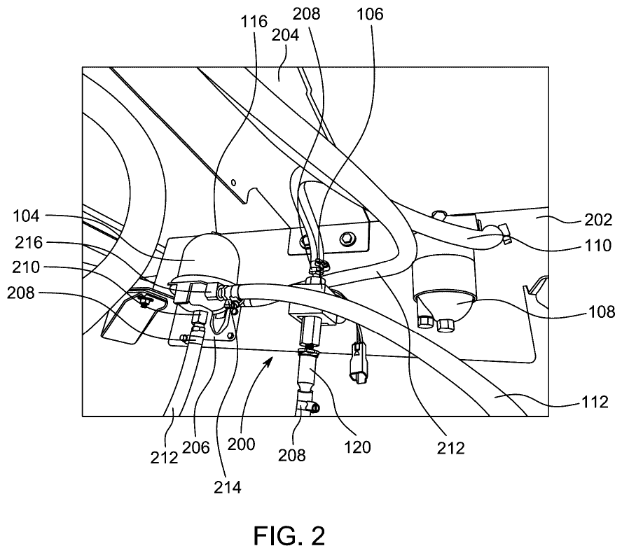

In some embodiments, the fuel deaeration system 100 may comprise a chassis fuel tank 102, a fuel deaerator 104, and a fuel pump 106. The fuel deaeration system 100 may further comprise a fuel filter/water separator 108, a generator fuel supply line 110, and a generator return fuel line 112. In some embodiments, the fuel deaeration system 100 may be installed within a vehicle (not shown). The vehicle may comprise at least van, motor home, caravan or the like. In some embodiments, the vehicle may comprise a vehicle chassis (shown in FIG. 2), vehicle body (shown in FIG. 2), on-board appliances (not shown), or the like. The vehicle chassis may be configured to provide structural integrity to the vehicle. The vehicle chassis may comprise structural steel or aluminum longitudinal rails, cross-members, suspension mounting points, engine cradles, and underbody brackets. The vehicle chassis may further comprise pre-formed cable channels, Original Equipment Manufacturer (OEM) fuel line conduits, vibration-isolated mounting points, and protected routing corridors that may enable installation of fuel pumps, valves, and fuel transfer components. In some embodiments, the vehicle body may be configured to support installation of interior systems and housing of various mechanical and electrical components associated with the vehicle. The vehicle body may comprise exterior panels, interior panels, under-floor storage compartments, insulation equipment, or the like.

In some embodiments, the on-board appliances may be configured to operate from a 12V/24V/48V Direct Current (DC) system or a 120V/240V Alternating Current (AC) system. In some embodiments, the on-board appliances may comprise Heating, Ventilation, Air-Conditioning (HVAC) systems, refrigerators, induction cooktops, water heaters, entertainment modules, lighting subsystems, and other auxiliary electronic equipment. The on-board appliances may generate dynamic load demands that require stable power generation, prompting integration of a generator 114. The vehicle may also be installed with the generator 114. In an exemplary embodiment, the generator 114 may correspond to a diesel generator. The generator 114 may be mounted on the vehicle chassis. In some embodiments, the generator 114 may be configured to provide a regulated power supply to the on-board appliances. In some embodiments, the generator 114 may require a stable and contamination-free fuel supply delivered at a specified pressure, temperature, and volumetric flow rate to generate the regulated power supply.

In some embodiments, the fuel deaeration system 100 may be configured for supplying the fuel to the generator 114. In some embodiments, the fuel deaeration system 100 may comprise the chassis fuel tank 102. In some embodiments, the chassis fuel tank 102 may be installed on the vehicle chassis. In some embodiments, the chassis fuel tank 102 may be configured to store fuel. The chassis fuel tank 102 may be fluidly coupled with an OEM fuel pump (not shown). Further, the OEM fuel pump may be configured to supply the fuel from the chassis fuel tank 102 to a power train (not shown) of the vehicle through fuel supply lines (not shown). In some embodiments, the chassis fuel tank 102 may be fluidly coupled with an inlet fuel line and an outlet fuel line. In some embodiments, the inlet fuel line may be configured to enable filling of the fuel within the chassis fuel tank 102.

In some embodiments, the fuel deaeration system 100 may comprise the fuel deaerator 104. The fuel deaerator 104 may be fluidly coupled to the chassis fuel tank 102. In some embodiments, the fuel deaerator 104 may be configured to receive the fuel therefrom. In some embodiments, the fuel deaerator 104 may be configured to receive through the outlet fuel line of the chassis fuel tank 102. In some embodiments, the fuel deaerator 104 may be configured to remove entrained air from the fuel. In some embodiments, the fuel deaerator 104 may be configured to separate entrained air from the fuel and retain the separated air within the fuel deaerator 104. In some embodiments, the fuel deaerator 104 may be configured to continuously remove the entrained air during both transient and steady-state operating conditions to reduce accumulation of air within downstream components of the fuel deaeration system 100.

In some embodiments, the fuel deaeration system 100 may comprise the fuel pump 106. The fuel pump 106 may be fluidly coupled downstream of the fuel deaerator 104. In some embodiments, the fuel pump 106 may be configured to draw fuel through the fuel deaerator 104. Further, the fuel pump 106 may be configured to deliver the fuel at a predetermined flow rate. The fuel pump 106 may comprise at least an electric pump, mechanical pump, or diaphragm-type pump configured to generate sufficient suction and discharge pressure to draw fuel through the fuel deaerator 104 and deliver the fuel to downstream components. In some embodiments, the fuel pump 106 may comprise a positive-displacement pump that may be configured to maintain a substantially continuous fuel velocity through the fuel filter/water separator 108 to break up or dissolve microbubbles remaining after the fuel deaerator 104 removes the entrained air from the fuel. In some embodiments, the fuel pump 106 may be configured to operate continuously during operation of the generator 114. The fuel pump 106 may be configured to continuously circulate the fuel through the fuel deaerator 104 to assist in ongoing removal of entrained air. The fuel pump 106 may further be configured to maintain a substantially stable fuel supply during transient operating conditions, including startup, shutdown, and load variations, to reduce pressure fluctuations and minimize introduction of additional air into the fuel.

The fuel deaeration system 100 may further comprise a fuel strainer 120. The fuel strainer 120 may be fluidly coupled between the fuel deaerator 104 and the fuel pump 106. In some embodiments, the fuel strainer 120 may be fluidly coupled to the fuel deaerator 104 through fuel supply lines. In some embodiments, the fuel strainer 120 may be configured to remove debris and particulate matter from the fuel, prior to entering the fuel pump 106. In some embodiments, the fuel strainer 120 may comprise a fine-mesh filtration element (not shown), a sediment collection chamber (not shown), or a multi-stage particulate-capture assembly (not shown) configured to retain solid contaminants and maintain fuel cleanliness. The fuel strainer 120 may further be configured to inhibit the transfer of abrasive particles and foreign matter to the fuel pump 106, thereby supporting consistent combustion performance and stable generator operation.

In an exemplary embodiment, the fuel strainer 120 may be installed upstream of the fuel deaerator 104. In such embodiments, the fuel strainer 120 may be fluidly coupled between the chassis fuel tank 102 and the fuel deaerator 104, and may be configured to remove debris and particulate matter from the fuel before the fuel enters the fuel deaerator 104.

In some embodiments, the fuel deaeration system 100 may further comprise the fuel filter/water separator 108. In some embodiments, the fuel filter/water separator 108 may be fluidly coupled downstream of the fuel pump 106. The fuel filter/water separator 108 may be configured to receive fuel from the fuel pump 106. In some embodiments, the fuel filter/water separator 108 may be configured to remove residual entrained air from the fuel. In some embodiments, the fuel filter/water separator 108 may be configured to reduce residual entrained air remaining after passage through the fuel deaerator 104. In some embodiments, the fuel filter/water separator 108 may be configured to dissipate microbubbles from the fuel by at least one of absorbing the microbubbles into the fuel under pressure, and mechanically subdividing the microbubbles into particles too small to interfere with operation of the generator 114.

In some embodiments, the fuel filter/water separator 108 may comprise a fine-mesh filtration element (not shown), a water-separation chamber (not shown), or a flow-stabilizing cavity (not shown) configured to slow the flow of the fuel and promote separation of entrained air. The fuel filter/water separator 108 may further be configured to prevent particulate contaminants and moisture from reaching the generator 114, thereby supporting consistent combustion and stable generator operation. In some embodiments, the fuel filter/water separator 108 may also be configured to enhance fuel deaeration downstream of the fuel deaerator 104 by allowing absorbed or mechanically subdivided micro-bubbles to pass through the generator 114 while ensuring clean, dry, and continuous fuel delivery to the generator 114.

In some embodiments, the fuel deaeration system 100 may comprise the generator fuel supply line 110. In some embodiments, the generator fuel supply line 110 may be fluidly coupled between the fuel filter/water separator 108 and the generator 114. In some embodiments, the generator fuel supply line 110 may be configured to receive filtered fuel from the fuel filter/water separator 108. In some embodiments, the generator fuel supply line 110 may be configured to deliver the filtered fuel to the generator 114. In some embodiments, the generator fuel supply line 110 may comprise one or more tubes. The one or more tubes may have a predetermined internal diameter selected to reduce formation and accumulation of entrained air and minimize a number of hose connections among the chassis fuel tank 102, the fuel deaerator 104, the fuel pump 106, the fuel filter/water separator 108, and the generator 114. In some embodiments, the predetermined internal diameter may comprise approximately 5/16 inch, thereby reducing suction losses, minimizing air accumulation, and ensuring compatibility with multiple generator configurations.

As illustrated in FIG. 1B, the fuel deaeration system 100 may comprise the generator return fuel line 112. In some embodiments, the generator return fuel line 112 may be fluidly coupled between the generator 114 and the fuel deaerator 104. In some embodiments, the generator return fuel line 112 may be configured to return unused fuel and entrained air from the generator 114 to the fuel deaerator 104. Further, the fuel deaerator 104 may be configured to remove air introduced into the fuel from the generator 114 through the generator return fuel line 112. In some embodiments, the generator return fuel line 112 may comprise one or more tubes. The one or more tubes may have a predetermined internal diameter selected to reduce formation and accumulation of entrained air and minimize a number of hose connections among the fuel deaerator 104, and the generator 114. In some embodiments, the predetermined internal diameter may comprise approximately 5/16 inch, thereby minimizing air accumulation, and ensuring compatibility with multiple generator configurations. In some embodiments, the generator return fuel line 112 may be fluidly isolated from the chassis fuel tank 102 to preserve compliance with vehicle manufacturer restrictions prohibiting return of the fuel to the chassis fuel tank 102.

In some embodiments, the fuel deaeration system 100 may comprise a vent outlet 116. In some embodiments, the vent outlet 116 may be fluidly coupled to the fuel deaerator 104. In some embodiments, the vent outlet 116 may be configured to expel air from and to optionally route the expelled air externally of the vehicle chassis. In some embodiments, the vent outlet 116 may be configured to expel the air removed from the fuel during deaeration of the fuel. In some embodiments, the vent outlet 116 may be configured to fluidly communicate with an upper region of the fuel deaerator 104 to allow separated air to be discharged while substantially preventing the fuel from exiting through the vent outlet 116. In some embodiments, the vent outlet 116 may include a float valve 118. In some embodiments, the float valve 118 may be configured to prevent liquid fuel discharge during fault conditions. In some embodiments, the fuel deaeration system 100 is configured to maintain a generator inlet fuel temperature below a predetermined threshold compliant with generator-manufacturer specifications during ambient temperatures of up to 48.9° C.

FIG. 2 illustrate a perspective view of the fuel deaeration system 100 installed on the vehicle chassis 200, in accordance with an example embodiment of the present disclosure.

In some embodiments, the fuel deaeration system 100 may be installed directly on an underside of the vehicle chassis 200. In an exemplary embodiment, the fuel deaeration system 100 may be positioned in close proximity to the chassis fuel tank 102 and along an existing fuel routing path. In some embodiments, the fuel deaerator 104 may be mounted at an elevation above the chassis fuel tank 102 so as to inhibit siphoning of the fuel from the chassis fuel tank 102 in cases of fuel deaerator failures and to maintain compliance with manufacturer requirements. The fuel deaerator 104 may be mounted in a protected location defined by structural members of the vehicle chassis 200, such as longitudinal rails 202 and cross-members 204, so as to minimize exposure to road debris while maintaining accessibility for service.

In some embodiments, the fuel deaerator 104 may be secured to the vehicle chassis 200 using a mounting bracket 206. The mounting bracket 206 may be fixed to the vehicle chassis 200. In an exemplary embodiment, the fuel deaerator 104 may be strategically positioned such that gravitational separation of the entrained air within an internal chamber of the fuel deaerator 104 may be promoted. In some embodiments, the deaerator may be oriented so that an upper region of the internal chamber may be positioned above a lower region, thereby facilitating upward migration and collection of entrained air during operation of the generator 114.

As illustrated in FIG. 2, a plurality of fuel lines 212 may extend from the chassis fuel tank 102 and may be routed along the underside of the vehicle chassis 200. In some embodiments, the plurality of fuel lines 212 may be fluidly coupled to a deaerator inlet port 210. The plurality of fuel lines 212 may be configured to supply the fuel from the chassis fuel tank 102 to the fuel deaerator 104. In some embodiments, the plurality of fuel lines 212 may be secured to their respective hose barbs by clamps 208, preventing leakage. Further, the fuel deaerator 104, the fuel pump 106, the fuel strainer 120, and the fuel filter/water separator 108 are mounted downstream of the chassis fuel tank 102 and similarly secured to the vehicle chassis 200. In some embodiments, the plurality of fuel lines 212 may be fluidly coupled between a deaerator outlet port 214 and the fuel pump 106. Further, the plurality of fuel lines 212 may be configured to supply the fuel from the fuel deaerator 104 to the fuel pump 106.

In some embodiments, the fuel pump 106 and the fuel strainer 120 may be fluidly coupled to the fuel filter/water separator 108 through the plurality of fuel lines 212, that may be configured to transfer the fuel to the fuel filter/water separator 108. The fuel filter/water separator 108 is mounted in a location that remains readily accessible while remaining shielded by chassis structures. The generator fuel supply line 110 may be routed from downstream of the fuel filter/water separator 108 to the generator 114, while the generator return fuel line 112 may be routed back along the vehicle chassis 200 to a deaerator return port 216.

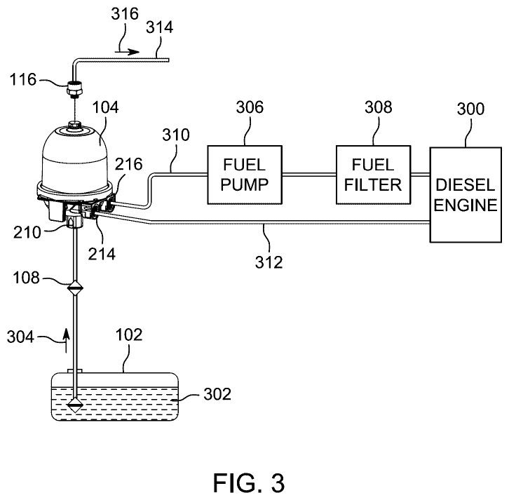

FIG. 3 illustrates an architectural view of the fuel deaeration system 100 for a diesel engine 300, in accordance with a second example embodiment of the present disclosure.

In some embodiments, the fuel deaeration system 100 may be operably coupled with the diesel engine 300 as an auxiliary fuel-consuming device. In some embodiments, the fuel deaeration system 100 may be fluidly coupled between the chassis fuel tank 102 and the diesel engine 300 to provide conditioned fuel while preventing return of aerated fuel to the chassis fuel tank 102. In some embodiments, the chassis fuel tank 102 may be configured to store the fuel 302 and deliver the fuel 302 to downstream components of the fuel deaeration system 100.

In some embodiments, the fuel 302 may be delivered from the chassis fuel tank 102 to the fuel deaerator 104 positioned downstream of the chassis fuel tank 102, as shown by arrow 304. In some embodiments, the fuel deaerator 104 may be configured to receive the fuel 302 from the chassis fuel tank 102. The fuel deaerator 104 may be configured to receive the fuel 302 at a first flow rate and to remove entrained air from the fuel 302 prior to downstream delivery. In some embodiments, the deaerated fuel may be delivered from the fuel deaerator 104 to a fuel pump 306 positioned downstream of the fuel deaerator 104. The fuel pump 306 may be configured to draw the deaerated fuel from the fuel deaerator 104 and deliver the fuel 302 at a predetermined flow rate and pressure suitable for operation of the diesel engine 300 to a fuel filter 308. In some embodiments, the fuel pump 306 may comprise at least one of an electric pump, mechanical pump, or diaphragm-type pump. The fuel pump 306 may be configured to ensure continuous circulation of the fuel 302 through the fuel deaerator 104 to assist in ongoing removal of entrained air under transient and steady-state operating conditions.

In some embodiments, the fuel filter 308 may be fluidly coupled downstream of the fuel pump 306 and upstream of the diesel engine 300. The fuel filter 308 may be configured to remove residual particulate matter and remaining microbubbles from the fuel 302 prior to delivery to the diesel engine. The fuel filter 308 may further be configured to dissipate microbubbles through localized pressure differentials and controlled flow paths, thereby providing substantially air-free fuel to the diesel engine 300. In some embodiments, the diesel engine 300 may comprise one or more fuel inlet ports (not shown) configured to receive the filtered fuel from the fuel filter 308 through a fuel supply line 310. The filtered fuel may be delivered to one or more injectors or fuel delivery components of the diesel engine 300 for combustion. In some embodiments, excess fuel from the diesel engine 300, including unused fuel and fuel containing entrained air introduced during engine operation, may be routed back to the fuel deaerator 104 through a return fuel line 312.

The returned fuel may be introduced into the internal chamber of the fuel deaerator 104. Further, the entrained air may be separated from the fuel 302. The deaerated fuel may be retained within the fuel deaerator 104 for subsequent recirculation to the diesel engine 300. In some embodiments, the fuel deaerator 104 may further comprise the vent outlet 116 positioned at the upper region of the fuel deaerator 104. The vent outlet 116 may be configured to discharge separated air to atmosphere, without permitting the deaerated fuel to escape. In some embodiments, the vent outlet 116 may be fluidly coupled to an optional vent line 314, as shown by arrow 316. In some embodiments, the optional vent line 314 may be configured to route removed air and vapors away from occupied regions of the vehicle.

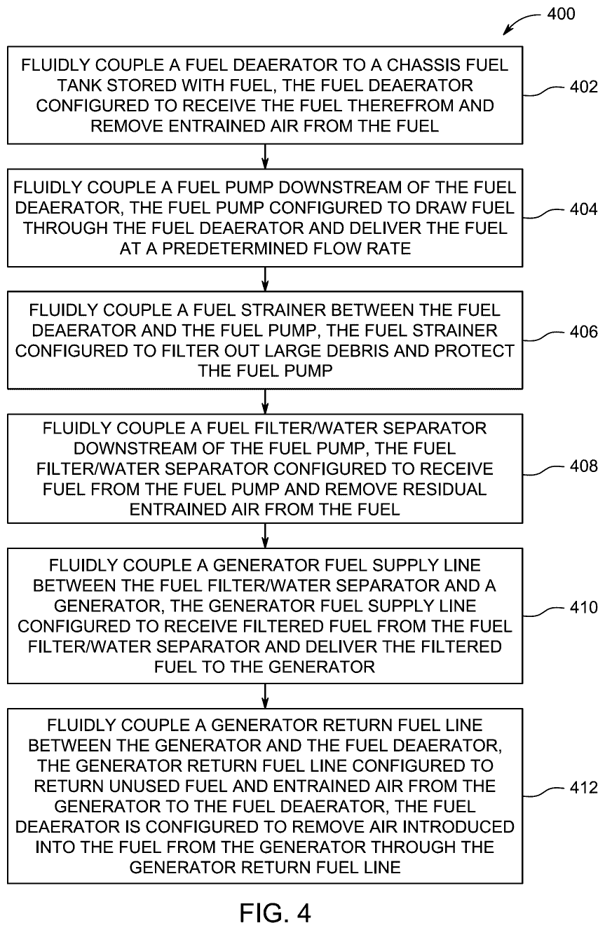

FIG. 4 illustrates a flowchart showing a method 400, in accordance with an example embodiment of the present disclosure.

At operation 402, the fuel deaerator is fluidly coupled to the chassis fuel tank 102 stored with the fuel 302, the fuel deaerator 104 configured to receive the fuel therefrom and remove entrained air from the fuel 302. In some embodiments, the chassis fuel tank 102 may be installed on the vehicle chassis 200. In some embodiments, the chassis fuel tank 102 may be configured to store the fuel 302. In some embodiments, the chassis fuel tank 102 may be fluidly coupled with the inlet fuel line and the outlet fuel line. In some embodiments, the inlet fuel line may be configured to enable filling of the fuel 302 within the chassis fuel tank 102. In some embodiments, the fuel deaerator 104 may be configured to receive through the outlet fuel line of the chassis fuel tank 102. In some embodiments, the fuel deaerator 104 may be configured to separate entrained air from the fuel 302 and retain the separated air within the upper region of the fuel deaerator 104. In some embodiments, the fuel deaerator 104 may be configured to configured to continuously remove the entrained air during both transient and steady-state operating conditions to reduce accumulation of air within downstream components of the fuel deaeration system 100.

At operation 404, the fuel pump 106 is fluidly coupled downstream of the fuel deaerator 104, the fuel pump 106 configured to draw fuel through the fuel deaerator 104 and deliver the fuel 302 at a predetermined flow rate. The fuel pump 106 may comprise at least an electric pump, mechanical pump, or diaphragm-type pump configured to generate sufficient suction and discharge pressure to draw fuel through the fuel deaerator 104 and deliver the fuel 302 to downstream components. In some embodiments, the fuel pump 106 may comprise a positive-displacement pump that may be configured to maintain a substantially continuous fuel velocity through the fuel filter/water separator 108 to break up or dissolve microbubbles remaining after the fuel deaerator 104 removes the entrained air from the fuel 302. In some embodiments, the fuel pump 106 may be configured to operate continuously during operation of the generator 114. The fuel pump 106 may be configured to continuously circulate the fuel 302 through the fuel deaerator 104 to assist in ongoing removal of entrained air. The fuel pump 106 may further be configured to maintain a substantially stable fuel supply during transient operating conditions, including startup, shutdown, and load variations, to reduce pressure fluctuations and minimize introduction of additional air into the fuel 302.

At operation 406, the fuel strainer 120 is fluidly coupled between the fuel deaerator 104 and the fuel pump 106. The fuel strainer 120 is configured to protect the fuel pump 106 from debris. In some embodiments, the fuel strainer 120 may be fluidly coupled to the fuel deaerator 104 through fuel supply lines. In some embodiments, the fuel strainer 120 may be configured to remove debris and particulate matter from the fuel, prior to entering the fuel pump 106. In some embodiments, the fuel strainer 120 may comprise a fine-mesh filtration element (not shown), a sediment collection chamber (not shown), or a multi-stage particulate-capture assembly (not shown) configured to retain solid contaminants and maintain fuel cleanliness. The fuel strainer 120 may further be configured to inhibit the transfer of abrasive particles and foreign matter to the fuel pump 106, thereby supporting consistent combustion performance and stable generator operation.

At operation 408, the fuel filter/water separator 108 is fluidly coupled downstream of the fuel pump 106, the fuel filter/water separator 108 configured to receive the fuel 302 from the fuel pump 106 and remove residual entrained air from the fuel 302. In some embodiments, the fuel filter/water separator 108 may be configured to remove particulate contaminants from the fuel 302 while further reducing residual entrained air remaining after passage through the fuel deaerator 104. In some embodiments, the fuel filter/water separator 108 may be configured to dissipate microbubbles from the fuel 302 by at least one of absorbing the microbubbles into the fuel 302 under pressure, and mechanically subdividing the microbubbles into particles too small to interfere with operation of the generator 114. The fuel filter/water separator 108 may further be configured to maintain a substantially continuous flow of the fuel 302 during operation of the generator 114 while limiting pressure drop across the fuel filter/water separator 108 to within acceptable operating ranges. In some embodiments, the fuel filter/water separator 108 may be positioned downstream of the fuel pump 106 to reduce likelihood of air accumulation within the fuel filter/water separator 108 and facilitate more effective management of the entrained air prior to delivery of the fuel 302 to the generator 114.

At operation 410, the generator fuel supply line 110 is fluidly coupled between the fuel filter/water separator 108 and the generator 114, the generator fuel supply line 110 configured to receive filtered fuel from the fuel filter/water separator 108 and deliver the filtered fuel to the generator 114. In some embodiments, the generator fuel supply line 110 may comprise one or more tubes. The one or more tubes may have a predetermined internal diameter selected to reduce formation and accumulation of entrained air and minimize a number of hose connections among the chassis fuel tank 102, the fuel deaerator 104, the fuel pump 106, the fuel filter/water separator 108, and the generator 114. In some embodiments, the predetermined internal diameter may comprise approximately 5/16 inch, thereby reducing suction losses, minimizing air accumulation, and ensuring compatibility with multiple generator configurations.

At operation 412, the generator return fuel line 112 is fluidly coupled between the generator 114 and the fuel deaerator 104, the generator return fuel line 112 configured to return unused fuel and entrained air from the generator 114 to the fuel deaerator 104. Further, the fuel deaerator 104 is configured to remove air introduced into the fuel 302 from the generator 114 through the generator return fuel line 112. In some embodiments, the generator return fuel line 112 may comprise one or more tubes. The one or more tubes may have a predetermined internal diameter selected to reduce formation and accumulation of entrained air and minimize a number of hose connections among the fuel deaerator 104, and the generator 114. In some embodiments, the predetermined internal diameter may comprise approximately 5/16 inch, thereby minimizing air accumulation, and ensuring compatibility with multiple generator configurations. In some embodiments, the generator return fuel line 112 may be fluidly isolated from the chassis fuel tank 102 to preserve compliance with vehicle manufacturer restrictions prohibiting return of the fuel 302 to the chassis fuel tank 102.

The present disclosure offers several notable advantages of the fuel deaeration system 100. The fuel deaeration system 100 enables controlled, reliable, and continuous delivery of conditioned fuel from the vehicle chassis 200 fuel tank 102 to the generator 114 or the auxiliary fuel-consuming device or diesel engine, while effectively removing entrained air prior to downstream delivery. By positioning the fuel deaerator 104 within the fuel supply and return architecture, the fuel deaeration system 100 mitigates cavitation, pressure instability, and flow interruption commonly associated with aerated fuel, thereby promoting stable combustion, reduced noise, and improved operational consistency during both startup and steady-state operation. The coordinated interaction between the fuel deaerator 104, downstream filtration components, downstream fuel pump 106, and associated supply and return fuel lines ensures that excess fuel and air generated during operation are recaptured and processed without permitting aerated or thermally affected fuel to return to the chassis fuel tank 102. The closed-loop fuel conditioning configuration enhances fuel system efficiency, protects high-pressure components from air-induced wear, and extends the service life of injectors, pumps, and associated fuel delivery hardware. From a safety and reliability perspective, the controlled venting of separated air and vapors reduces vapor accumulation within the fuel system and minimizes pressure-related disturbances. Additionally, the modular and compact architecture of the fuel deaeration system 100 simplifies integration across a range of auxiliary devices and diesel engines, reduces installation complexity, lowers maintenance requirements, and contributes to improved overall system robustness and cost-effectiveness.

Many modifications and other embodiments of the present disclosure set forth herein will come to mind to one skilled in the art to which this present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A fuel deaeration system for a generator mounted on a vehicle chassis, the fuel deaeration system comprising:
a chassis fuel tank configured to store fuel;
a fuel deaerator fluidly coupled to the chassis fuel tank and configured to receive the fuel therefrom and remove entrained air from the fuel;
a fuel pump fluidly coupled downstream of the fuel deaerator and configured to draw fuel through the fuel deaerator and deliver the fuel at a predetermined flow rate;
a fuel strainer fluidly coupled between the fuel deaerator and the fuel pump, wherein the fuel strainer is configured to protect the fuel pump from debris;
a fuel filter/water separator fluidly coupled downstream of the fuel pump and configured to receive fuel from the fuel pump and mitigate residual entrained air from the fuel;
a generator fuel supply line fluidly coupled between the fuel filter/water separator and the generator, and configured to receive filtered fuel from the fuel filter/water separator and deliver the filtered fuel to the generator; and
a generator return fuel line fluidly coupled between the generator and the fuel deaerator and configured to return unused fuel and entrained air from the generator to the fuel deaerator,
wherein the fuel deaerator is configured to remove air introduced into the fuel from the generator through the generator return fuel line.

2. The fuel deaeration system of claim 1, wherein the fuel deaerator comprises a vent outlet configured to expel air from the fuel and to optionally route the expelled air externally of the vehicle chassis.

3. The fuel deaeration system of claim 2, wherein the vent outlet includes a float valve configured to prevent liquid fuel discharge during fault conditions.

4. The fuel deaeration system of claim 1, wherein the fuel deaerator is mounted at an elevation above the chassis fuel tank so as to inhibit siphoning of the fuel from the chassis fuel tank in cases of fuel deaerator failures and to maintain compliance with manufacturer requirements.

5. The fuel deaeration system of claim 1, wherein the fuel pump comprises a positive-displacement pump configured to maintain a substantially continuous fuel velocity through the fuel filter/water separator to break up or dissolve microbubbles remaining after the fuel deaerator removes the entrained air from the fuel.

6. The fuel deaeration system of claim 1, wherein the fuel filter/water separator is configured
to dissipate microbubbles by at least one of:
absorbing the microbubbles into the fuel under pressure; and
mechanically subdividing the microbubbles into particles too small to interfere with operation of the generator.

7. The fuel deaeration system of claim 1, wherein the generator fuel supply line and the generator return fuel line comprises one or more tubes having a predetermined internal diameter selected to reduce formation and accumulation of entrained air and minimize a number of hose connections among the chassis fuel tank, the fuel deaerator, the fuel pump, the fuel filter/water separator, and the generator.

8. The fuel deaeration system of claim 7, wherein the predetermined internal diameter comprises approximately 5/16 inch, thereby reducing suction losses, minimizing air accumulation, and ensuring compatibility with multiple generator configurations.

9. The fuel deaeration system of claim 1, wherein the generator return fuel line is fluidly isolated from the chassis fuel tank to preserve compliance with vehicle manufacturer restrictions prohibiting return of the fuel to the chassis fuel tank.

10. The fuel deaeration system of claim 1, wherein the fuel deaeration system is configured to maintain a generator inlet fuel temperature below a predetermined threshold compliant with generator-manufacturer specifications during ambient temperatures of up to 48.9°C.

11. A method comprising:
fluidly coupling a fuel deaerator to a chassis fuel tank stored with fuel, the fuel deaerator configured to receive the fuel therefrom and remove entrained air from the fuel;
fluidly coupling a fuel pump downstream of the fuel deaerator, the fuel pump configured to draw fuel through the fuel deaerator and deliver the fuel at a predetermined flow rate;
fluidly coupling a fuel strainer between the fuel deaerator and the fuel pump, the fuel strainer configured to filter out large debris and protect the fuel pump;
fluidly coupling a fuel filter/water separator downstream of the fuel pump, the fuel filter/water separator configured to receive fuel from the fuel pump and remove residual entrained air from the fuel;
fluidly coupling a generator fuel supply line between the fuel filter/water separator and a generator, the generator fuel supply line configured to receive filtered fuel from the fuel filter/water separator and deliver the filtered fuel to the generator; and
fluidly coupling a generator return fuel line between the generator and the fuel deaerator, the generator return fuel line configured to return unused fuel and entrained air from the generator to the fuel deaerator,
wherein the fuel deaerator is configured to remove air introduced into the fuel from the generator through the generator return fuel line.

12. The method of claim 11, wherein the fuel deaerator comprises a vent outlet configured to expel air from the fuel and to optionally route the expelled air externally of the vehicle chassis.

13. The method of claim 12, wherein the vent outlet includes a float valve configured to prevent liquid fuel discharge during fault conditions.

14. The method of claim 11, further comprising mounting the fuel deaerator at an elevation above the chassis fuel tank so as to inhibit siphoning of the fuel from the chassis fuel tank in cases of fuel deaerator failures and to maintain compliance with manufacturer requirements.

15. The method of claim 11, wherein the fuel pump comprises a positive-displacement pump configured to maintain a substantially continuous fuel velocity through the fuel filter/water separator to break up or dissolve microbubbles remaining after the fuel deaerator removes the entrained air from the fuel.

16. The method of claim 11, wherein the fuel filter/water separator is configured to dissipate
microbubbles by at least one of:
absorbing the microbubbles into the fuel under pressure; and
mechanically subdividing the microbubbles into particles too small to interfere with operation of the generator.

17. The method of claim 11, wherein the generator fuel supply line and the generator return fuel line comprises one or more tubes having a predetermined internal diameter selected to reduce formation and accumulation of entrained air and minimize a number of hose connections among the chassis fuel tank, the fuel deaerator, the fuel pump, and the fuel filter/water separator.

18. The method of claim 17, wherein the predetermined internal diameter comprises approximately 5/16 inch, thereby reducing suction losses, minimizing air accumulation, and ensuring compatibility with multiple generator configurations.

19. The method of claim 11, further comprising fluidly isolating the generator return fuel line from the chassis fuel tank to preserve compliance with vehicle manufacturer restrictions prohibiting return of the fuel to the chassis fuel tank.

20. The method of claim 11, further comprising maintaining, via the fuel deaeration system, a generator inlet fuel temperature below a predetermined threshold compliant with generator-manufacturer specifications during ambient temperatures of up to 48.9°C.
